(19) United States
(12) Patent Application Publication
(10) Pub. No.: US 2026/0214328 A1
(43) Pub. Date: Jul. 23, 2026

(54) IMAGING DEVICE AND SHADING CORRECTION METHOD

(71) Applicant: Sony Group Corporation, Tokyo (JP)

(72) Inventor: Yasuo Sakai, Tokyo (JP)

(21) Appl. No.: 19/144,763

(22) PCT Filed: Jan. 23, 2024
(86) PCT No.: PCT/JP2024/001801

§ 371 Date: Jun. 30, 2025

(30) Foreign Application Priority Data
Feb. 20, 2023 (JP) 2023-024142

(51) Int. Cl. H04N 23/663; H04N 23/55; H04N 23/75

(52) U.S. Cl. CPC H04N 23/663; H04N 23/55; H04N 23/75

(57) ABSTRACT

An imaging device includes: a mount portion on which an interchangeable lens is mounted; a liquid crystal dimming element that performs dimming of incident light incident through a lens system in an interchangeable lens when the interchangeable lens is mounted on the mount portion; an imaging element that photoelectrically converts the incident light through the liquid crystal dimming element to generate a captured image signal; a signal processing unit that performs signal processing on the captured image signal output from the imaging element; and a control unit that causes the signal processing unit to execute shading correction processing of correcting shading caused by the liquid crystal dimming element with a correction coefficient set on the basis of a characteristic of an inclination of a liquid crystal of the liquid crystal dimming element.

### TECHNICAL FIELD

The present technology relates to a technical field of an imaging device including a liquid crystal dimming element.

### BACKGROUND ART

Imaging devices widely used as digital still cameras, video cameras, and the like include a lens and an imaging element provided on an optical axis of the lens. There is one in which a dimming element is provided between the lens and the imaging element and the amount of light from the lens toward the imaging element can be adjusted.

As the dimming element, a liquid crystal dimming element is known. An imaging device equipped with a liquid crystal dimming element is enabled to vary the ND density steplessly and perform automatic dimming according to various conditions.

Patent Document 1 below discloses shading correction in an imaging device equipped with a liquid crystal dimming element.

### CITATION LIST

### Patent Document

Patent Document 1: Japanese Patent Application Laid-Open No. 2017-54030

### SUMMARY OF THE INVENTION

### Problems to be Solved by the Invention

Shading generated in an image through a liquid crystal dimming element is correlated with an exit pupil distance and a transmittance of the liquid crystal dimming element.

In an interchangeable lens imaging device, information of the exit pupil distance is acquired by communication between an imaging device main body and a mounted interchangeable lens, and shading correction is performed on the basis of the information.

However, there are various models of interchangeable lenses, and there are also models in which the exit pupil distance cannot be acquired by communication. In that case, shading correction is not performed on the imaging device main body side.

Thus, the present disclosure proposes a technology for appropriately performing shading correction even in a case where the exit pupil distance cannot be obtained from the interchangeable lens in the interchangeable lens imaging device.

### Solutions to Problems

An imaging device according to the present. technology includes: a mount portion on which an interchangeable lens is mounted; a liquid crystal dimming element that performs dimming of incident light incident through a lens system in an interchangeable lens when the interchangeable lens is mounted on the mount portion; an imaging element that photoelectrically converts the incident light through the liquid crystal dimming element to generate a captured image signal; a signal processing unit that performs signal processing on the captured image signal output from the imaging element; and a control unit that causes the signal processing unit to execute shading correction processing of correcting shading caused by the liquid crystal dimming element with a correction coefficient set on the basis of a characteristic of an inclination of a liquid crystal of the liquid crystal dimming element.

For example, the control unit sets the correction coefficient for each of pixel values on the basis of the characteristic of the inclination of the liquid crystal of the liquid crystal dimming element, and indicates the correction coefficient for the signal processing unit.

### BRIEF DESCRIPTION OF DRAWINGS

FIG. 1 is an explanatory diagram of an imaging device according to an embodiment of the present technology.

FIG. 2 is an explanatory diagram of arrangement of a liquid crystal dimming element of the imaging device according to the embodiment.

FIG. 3 is a front view of the imaging device according to the embodiment in a state in which an interchangeable lens is removed.

FIG. 4 is a cross-sectional view illustrating a mechanism of the liquid crystal dimming element according to the embodiment.

FIG. 5 is an explanatory diagram of an adapter of an imaging device according to the embodiment.

FIG. 6 is a block diagram of an internal configuration of the imaging device according to the embodiment.

FIG. 7 is an explanatory diagram of a structure of the liquid crystal dimming element according to the embodiment.

FIG. 8 is an explanatory diagram of brightness and darkness due to an inclination of liquid crystal in the liquid crystal dimming element according to the embodiment.

FIG. 9 is an explanatory diagram of a change depending on a transmittance of the liquid crystal dimming element according to the embodiment.

FIG. 10 is an explanatory diagram of the amount of shading by the liquid crystal dimming element.

FIG. 11 is an explanatory diagram of a correction coefficient for pixels and blocks according to the embodiment.

FIG. 12 is an explanatory diagram of a correction coefficient table according to the embodiment.

FIG. 13 is an explanatory diagram of a functional configuration for shading correction according to the embodiment.

FIG. 14 is a flowchart of correction ON/OFF setting processing according to a first embodiment.

FIG. 15 is a flowchart of correction coefficient setting processing according to a first embodiment.

FIG. 16 is a flowchart of correction ON/OFF setting processing according to a second embodiment.

FIG. 17 is a flowchart of correction coefficient setting processing according to the second embodiment.

FIG. 18 is a flowchart of correction ON/OFF setting processing according to a third embodiment.

### MODE FOR CARRYING OUT THE INVENTION

Hereinafter, embodiments will be described in the following order.
<1. Structure of Imaging Device>
<2. Internal Configuration>
<3. Shading Correction>
[3-1: Shading by Liquid Crystal Dimming Element and Correction Coefficient Table]
[3-2: Functional Configuration for Shading Correction]
[3-3: Processing Example as First Embodiment]
[3-4: Processing Example as Second Embodiment]
[3-5: Processing Example as Third Embodiment]
[3-6: Shading Correction Corresponding to Lens System]
<4. Summary and Modification>

### 1. Structure of Imaging Device

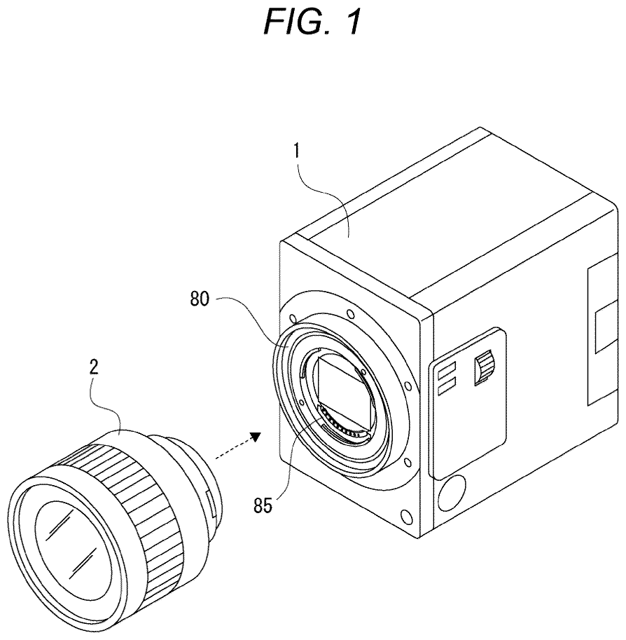

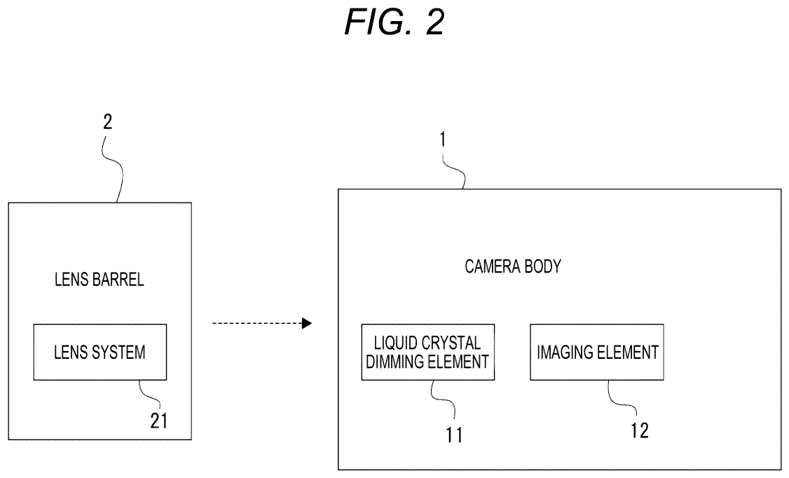

FIGS. 1 and 2 illustrate a schematic structure of an imaging device 1 according to an embodiment.

FIG. 1 illustrates the imaging device 1 and a lens barrel 2 as one of interchangeable lenses mountable on the imaging device 1. External shapes of the imaging device 1 and the lens barrel 2 illustrated in the drawing are merely examples. The present embodiment is basically an interchangeable lens video camera or digital still camera.

FIG. 2 schematically illustrates that a liquid crystal dimming element 11 and an imaging element 12 are disposed in a camera body of the imaging device 1.

A lens system 21 including optical components such as a plurality of lenses including a zoom lens and a focus lens is provided on the lens barrel 2 side. In the present embodiment, a configuration is adopted in which when the lens barrel 2 is mounted on the imaging device 1, incident light through the lens system 21 is dimmed by the liquid crystal dimming element 11 on the imaging device 1 side and received by the imaging element 12.

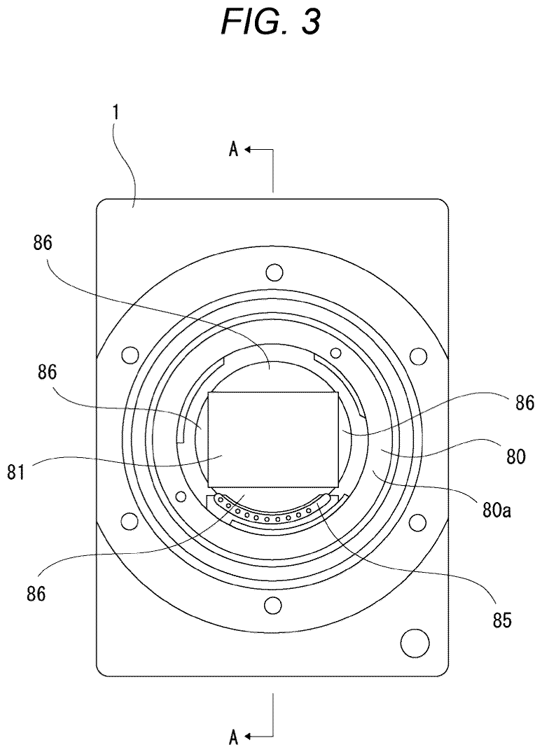

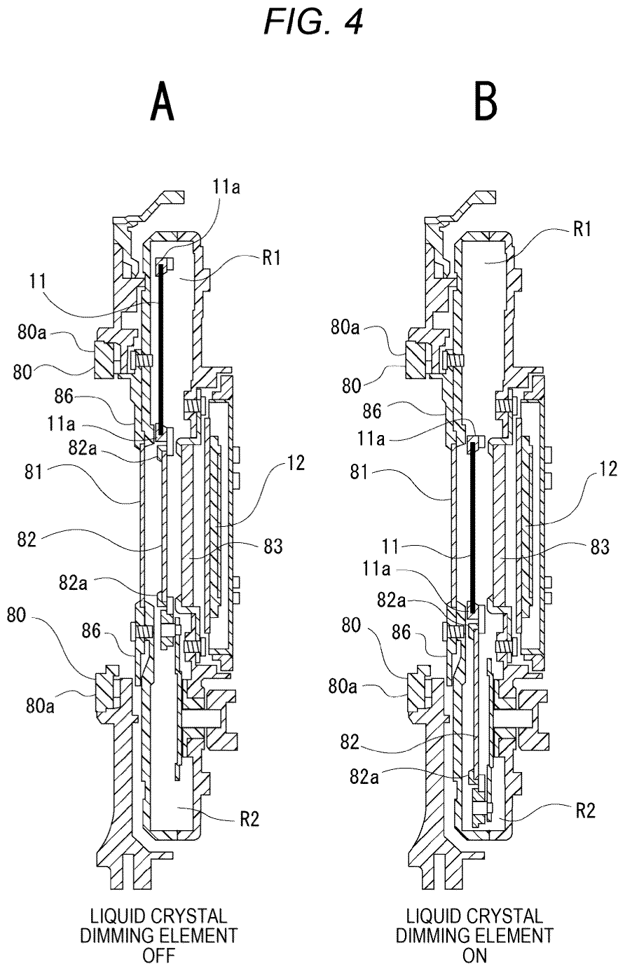

FIG. 3 is a front view of the imaging device 1, and FIGS. 4A and 4B illustrate an optical system portion up to the imaging element 12 as a part of an A-A cross section of FIG. 3.

FIG. 3 is a front view of a state in which the lens barrel 2 is not mounted, and thus a mount portion 80 for mounting the lens barrel 2 is exposed on the front side.

A terminal portion 85 is provided on the inner peripheral side along a mount ring 80a constituting the mount portion 80. The terminal portion 85 is a plurality of electrical contacts, and functions as a communication terminal for communicating with the lens barrel 2 to which the imaging device 1 is connected. The lens barrel 2 corresponding to the imaging device 1 is provided with electrical contacts that come into contact with the electrical contacts of the terminal portion 85 in the mounted state, and a communication path between the imaging device 1 and the lens barrel 2 is formed by this contact state.

On the inner peripheral side of the mount ring 80a, a cover glass 81 is disposed as an opening portion for taking in the incident light. Note that this is an example, and there is also a configuration in which the Cover glass 81 is not provided.

The periphery of the cover glass 81 is a mold portion 86 by which the incident light is blocked. The configuration illustrated in FIGS. 4A and 4B is disposed toward the optical axis direction from the cover glass 81.

FIG. 4A illustrates an example of a state in which the liquid crystal dimming element 11 is retracted from an incident light path, and FIG. 4B illustrates an example of a state in which the liquid crystal dimming element 11 is disposed in the incident light path.

For example, normally, the liquid crystal dimming element 11 is disposed as illustrated in FIG. 4B to exhibit a dimming function by the liquid crystal dimming element 11. On the other hand, in a case where it is desired to increase the amount of incident light, by retracting the liquid crystal dimming element 11 as illustrated in FIG. 4A, it is possible to bring about a substantially 100% transmission state.

In the state of FIG. 4B, the cover glass 81, the liquid crystal dimming element 11, an optical low-pass filter 83, and the imaging element 12 are disposed in the order of the traveling direction (optical axis direction) of the incident light. Note that the order of arrangement of the liquid crystal dimming element 11 and the optical low-pass filter 83 may be reversed.

In the state of FIG. 4A, the cover glass 81, a clear glass 82, the optical low-pass filter 83, and the imaging element 12 are disposed in this order in the traveling direction of the incident light.

Note that the order of arrangement of the clear glass 82 and the optical low-pass filter 83 may be reversed.

In this example, it is assumed that the liquid crystal dimming element 11 is retracted to a space R1 in the state of FIG. 4A, and the clear glass 82 is retracted to a space R2 in the state of FIG. 4B.

At the time of retracting of the liquid crystal dimming element 11 in FIG. 4A, the liquid crystal dimming element 11 moves to a position where the position in the optical axis direction does not overlap with the cover glass 81, and after the movement, the position in the optical axis direction overlaps with at least the mount. ring 80a. Moreover, in that state, the position in the optical axis direction of the liquid crystal dimming element 11 overlaps also with the mold portion 86.

The position of the liquid crystal dimming element. 11 in the retracted state is set to a position overlapping with the mount ring 80a and the mold portion 86 as viewed in the optical axis direction (as viewed from the subject side), whereby the space R1 can be reduced. That is, when the liquid crystal dimming element 11 is further retracted upward in the drawing, it is necessary to expand the space R1 in a direction perpendicular to the optical axis, but the space RI can be minimized by setting of the retracted position as illustrated in the drawing.

Furthermore, in the state of FIG. 4B, the position in the optical axis direction of the clear glass 82 overlaps with the mount ring 80a. Moreover, in that state, the position in the optical axis direction of the mount ring 80a overlaps also with the mold portion 86.

The position of the clear glass 82 in the retracted state is set to a position overlapping with the mount ring 80a and the mold portion 86 as viewed in the optical axis direction (as viewed from the subject side), whereby the space R2 can be reduced. That is, when the clear glass 82 is further retracted downward in the drawing, it is necessary to expand the space R2 in the direction perpendicular to the optical axis, but the space R2 can be minimized by setting of the retracted position as illustrated in the drawing.

In this example, it is assumed that the clear glass 82 is disposed in the incident light path when the liquid crystal dimming element 11 is retracted from the incident light path, and this is for making a state close to an optical state in a case where the liquid crystal dimming element 11 is included even when the liquid crystal dimming element 11 is retracted. For this reason, the clear glass 82 has a function of matching optical lengths of both cases in consideration of the refractive index of the material.

Furthermore, the liquid crystal dimming element 11 is held by a holder 11a, and the clear glass 82 is held by a holder 82a. Then, the holders 11a and 82a are vertically moved together in a state of being coupled together, whereby the liquid crystal dimming element 11 is inserted/retracted.

With this mechanism, the movement of the liquid crystal dimming element 11 and the clear glass 82 can be integrally executed, a mechanism for retracting the liquid crystal dimming element 11 and returning from the retraction is simplified, and operation of switching insertion of the liquid crystal dimming element 11 and the clear glass 82 to the incident light path is stabilized.

Note that a retracted direction (retracted position) of the clear glass 82 may be 180 degrees opposite to the retracted direction (retracted position) of the liquid crystal dimming element 11 across the imaging element 12, or may be retracted in a direction different by 90 degrees. Moreover, the retracted direction (retracted position) of the clear glass 82 may be the same direction (position) as the retracted direction (retracted position) of the liquid crystal dimming element 11.

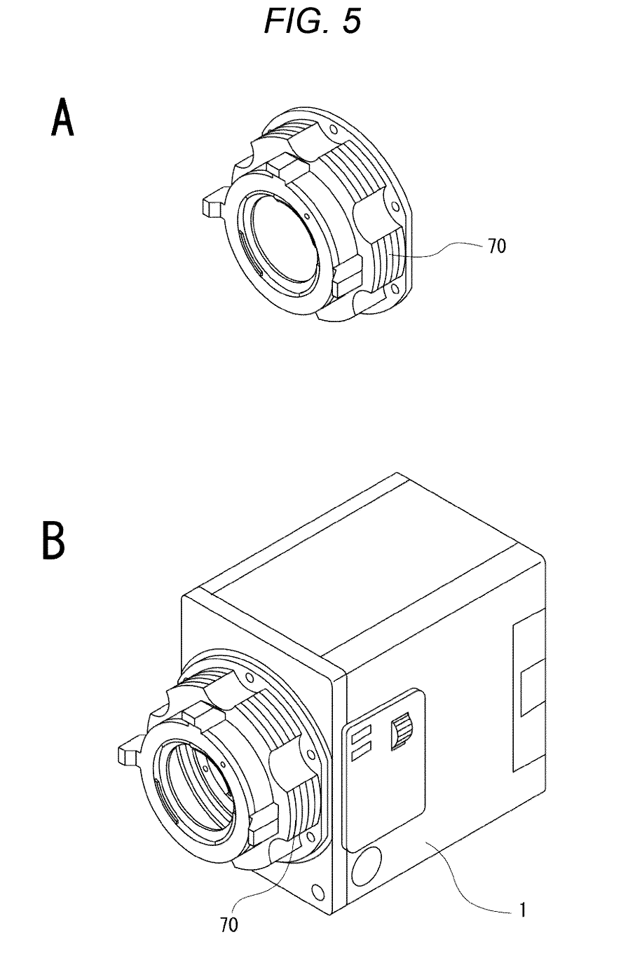

FIG. 5A illustrates an adapter 70.

The adapter 70 is used to mount the lens barrel 2 of a type not corresponding to the mount portion 80.

As illustrated in FIG. 5B, the adapter 70 is mountable on the mount portion 80. In this state, an interchangeable lens with a different mount is mountable on the adapter 70.

### 2. Internal Configuration

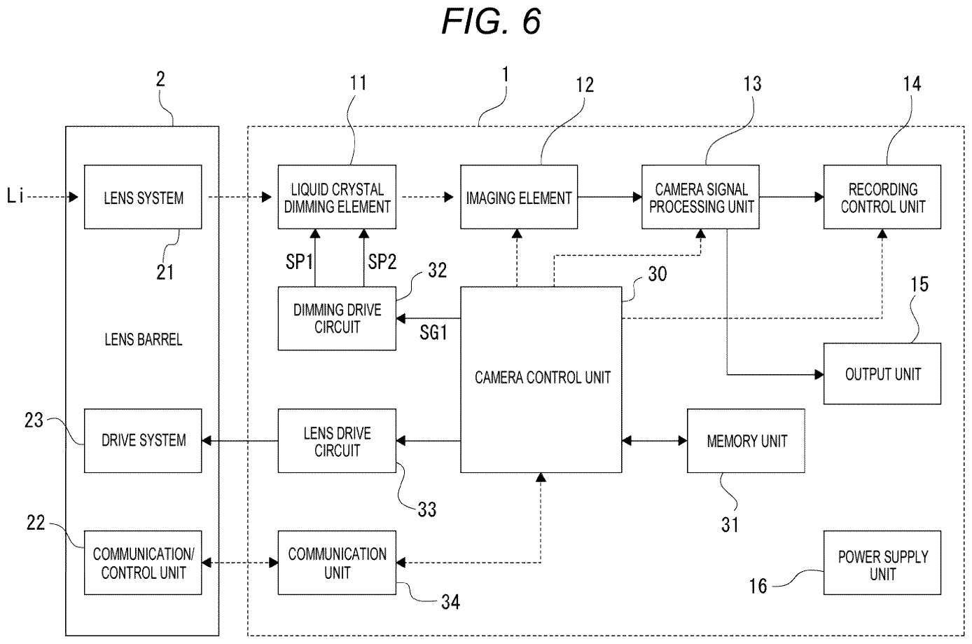

FIG. 6 illustrates an internal configuration of the imaging device 1 according to the embodiment. At the same time, the lens barrel 2 mounted on the imaging device 1 is also illustrated.

The imaging device 1 includes the liquid crystal dimming element 11, the imaging element (imager) 12, a camera signal processing unit 13, a recording control unit 14, an output unit 15, a power supply unit 16, a camera control unit 30, a memory unit 31, a dimming drive circuit 32, a lens drive circuit 33, and a communication unit 34.

Note that, although not illustrated, a configuration for a user interface is usually provided, such as a display unit or an operation unit.

The lens system 21 in the lens barrel 2 includes a lens such as a cover lens, a zoom lens, and a focus lens, and an aperture mechanism. Light (incident light Li) from a subject is guided by the lens system 21 and condensed on the imaging element 12 through the liquid crystal dimming element 11 in the imaging device 1.

The liquid crystal dimming element 11 adjusts the amount of incident light Li. A configuration of the liquid crystal dimming element 11 will be described later.

The imaging element 12 is configured as, for example, a charge coupled device (CCD) type, a complementary metal oxide semiconductor (CMOS) type, or the like.

The imaging element 12 executes, for example, correlated double sampling (CDS) processing, automatic gain control (AGC) processing, or the like on an electric signal obtained by photoelectric conversion of the received light, and further performs analog/digital (A/D) conversion processing. Then, an imaging signal as digital data is output to the camera signal processing unit 13 in the subsequent stage.

The camera signal processing unit 13 is configured as, for example, an image processing processor using a digital signal processor (DSP) or the like. This camera signal processing unit 13 performs various types of signal processing on a digital signal (captured image signal) from the imaging element 12. For example, the camera signal processing unit 13 performs preprocessing, simultaneous processing, YC generation processing, resolution conversion processing, codec processing, or the like.

In the preprocessing, clamping processing of clamping black levels of R, G, and B to a predetermined level, correction processing among color channels of R, G, and B, or the like is performed on the captured image signal from the imaging element 12.

In the simultaneous processing, color separation processing is performed such as demosaicing in which image data for each pixel is made to have all color components of R, G, and B.

In the YC generation processing, a luminance (Y) signal and a color (C) signal are generated (separated) from the image data of R, G, and B.

In the resolution conversion processing, resolution conversion processing is executed on the image data subjected to various types of signal processing.

In the codec processing, for example, encoding processing for recording or communication is performed on the resolution-converted image data.

In particular, in the case of the present embodiment, the camera signal processing unit 13 also performs correction processing for correcting shading generated by imaging of the incident light Li through the liquid crystal dimming element 11 and correction processing for correcting shading caused by the lens system 21 at the stage of the above-described preprocessing, for example.

The recording control unit 14 performs processing of storing image files (content files) such as still image data and moving image data, attribute information on the image files, thumbnail images, and the like in a recording medium, for example a nonvolatile memory or the like.

The image files are stored in formats such as Joint Photographic Experts Group (JPEG), Tagged Image File Format (TIFF), or Graphics Interchange Format (GIF), for example.

Various actual forms of the recording control unit 14 are conceivable. For example, the recording control unit 14 may have a form of performing recording and reproduction on a flash memory built in the imaging device 1, or have a form as a card recording and reproduction unit that performs recording and reproduction access to a memory card (for example, a portable flash memory) that can be attached to and detached from the imaging device 1. Furthermore, it may be implemented as a hard disk drive (HDD), a solid state drive (SDD), or the like as a form built in the imaging device 1.

The output unit 15 performs data communication and network communication with external devices by wire or wirelessly.

For example, captured image data (still image file or moving image file) is transmitted and output to an external display device, recording device, reproduction device, or the like.

Furthermore, the output unit 15 may be assumed to be a network communication unit, and perform communication via various networks, for example, the Internet, a home network, a local area network (LAN), and the like, and transmit and receive various data to and from a server, a terminal, and the like on the network.

The power supply unit 16 generates a power supply voltage necessary for each unit by using, for example, a voltage of a built-in battery or a DC voltage converted and input by an AC adapter connected to a commercial AC power supply as a power supply, and supplies the generated power supply voltage as an operating voltage.

The camera control unit 30 includes a microcomputer (arithmetic processing unit) equipped with a central processing unit (CPU).

The memory unit 31 stores information and the like used by the camera control unit 30 for processing. It comprehensively represents, for example, a read only memory (ROM), a random access memory (RAM), a flash memory, and the like. The memory unit 31 may be a memory area built in a microcomputer chip that serves as the camera control unit 30 or may be a separate memory chip.

The camera control unit 30 executes a program stored in the ROM, the flash memory, or the like of the memory unit 31 to integrally control the entire imaging device 1.

For example, the camera control unit 30 controls operation of each of necessary units, for control of shutter speed of the imaging element 12, instructions for various types of signal processing in the camera signal processing unit 13, an imaging operation and a recording operation according to user operations, an operation for reproducing a recorded image file, a camera operation such as zoom, focus, and exposure adjustment, a user interface operation, and the like.

The RAM in the memory unit 31 is used for temporary storage of data, a program, and the like as a work area during various types of data processing by the CPU.

The ROM and the flash memory (non-volatile memory) in the memory unit 31 are used to store an operating system (OS) for the CPU to control each unit, content files such as image files, application programs for various operations, firmware, and the like.

Furthermore, in the present embodiment, a correction table for shading correction described later is stored in a flash memory for example.

The dimming drive circuit 32 drives the liquid crystal dimming element 11 by liquid crystal drive signals SP1 and SP2 to change a transmittance. The dimming drive circuit 32 sets amplitude levels of the liquid crystal drive signals SP1 and SP2 on the basis of a brightness indication (dimming control signal SG1) from the camera control unit 30, for example, and outputs the signals to the liquid crystal dimming element 11.

Note that a reason why the liquid crystal drive signals of two systems are illustrated as the liquid crystal drive signals SP1 and SP2 is that the liquid crystal dimming element 11 has a two-layer structure and drives each liquid crystal layer as will be described later as an example of the embodiment.

The lens drive circuit 33 outputs a drive signal for a drive system 23 of the lens barrel 2 on the basis of an instruction from the camera control unit 30.

The drive system 23 of the lens barrel 2 includes, for example, a motor that drives a focus lens or a zoom lens in the lens system 21, a motor that drives the aperture mechanism, and the like. The lens drive circuit 33 outputs drive signals for these motors to cause the lens barrel 2 to execute a required operation.

The communication unit 34 communicates with the lens barrel 2.

The lens barrel 2 is equipped with, for example, a communication/control unit 22 using a microcomputer, and the camera control unit 30 is enabled to perform various types of data communication with the communication/control unit 22 via the communication unit 34. In the case of the present embodiment, the camera control unit 30 can acquire information on the lens barrel 2, for example, a model, a lens type, and the like through communication by the communication unit 34. Furthermore, the camera control unit 30 acquires information of the exit pupil distance of the lens system 21 as information regarding shading correction through communication by the communication unit 34.

Note that communication between the communication unit 34 and the communication/control unit 22 and supply of a motor drive signal from the lens drive circuit 33 to the drive system 23 are performed by wired connection via the terminal portion 85 illustrated in FIG. 3 (and a terminal portion on the lens barrel 2 side (not illustrated)).

In a case where the lens barrel 2 is mounted with the adapter 70 interposed therebetween, the terminal portion 85 for communication is electrically connected to a contact of the lens barrel 2 with the adapter 70 interposed therebetween, whereby information communication is enabled. However, for example, there is the lens barrel 2 of a type in which information of the exit pupil distance cannot be obtained even if the communication is enabled. Furthermore, there is also the lens barrel 2 that does not communicate with the imaging device 1.

A description will be given of the liquid crystal dimming element 11 mounted on the imaging device 1 having the above configuration.

The liquid crystal dimming element 11 is a dimming device using a guest-host (GH) liquid crystal cell.

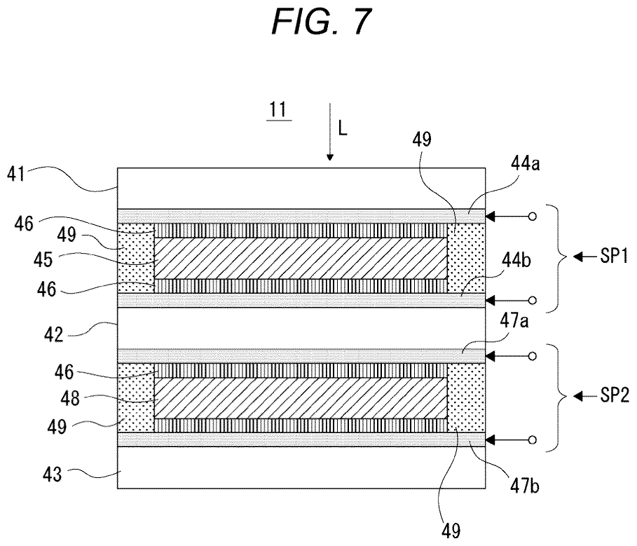

FIG. 7 illustrates a structure of the liquid crystal dimming element 11.

The liquid crystal dimming element 11 is provided with glass substrates 41, 42, and 43, and includes two liquid crystal layers 45 and 48 with respect to a traveling direction (arrow L) of light to be dimmed.

First, the glass substrates 41 and 42 are disposed with a sealing material 49 interposed therebetween as illustrated, and the liquid crystal layer 45, which is one of the two liquid crystal layers, is formed therebetween. Transparent electrode films 44a and 44b are provided on the liquid crystal layer side of the glass substrates 41 and 42, respectively. Furthermore, alignment films 46 and 46 are provided on both sides of the liquid crystal layer 45.

Furthermore, the glass substrates 42 and 43 are also disposed with the sealing material 49 interposed therebetween as illustrated, and the liquid crystal layer 48, which the other of the two liquid crystal layers, is formed therebetween. Transparent electrode films 47a and 47b are provided on the liquid crystal layer side of the glass substrates 42 and 43, respectively. Furthermore, alignment films 46 and 46 are provided on both sides of the liquid crystal layer 48.

For example, the sealing material 49 seals the liquid crystal layers 45 and 48 from the side surface side. The sealing material 49 includes an adhesive, for example, an epoxy adhesive, an acrylic adhesive, or the like.

Note that, FIG. 7 illustrates the structure in the cross-sectional direction, and the liquid crystal dimming element 11 further includes a sealing portion and a spacer (not illustrated).

The spacer may be disposed to hold a cell gap between the liquid crystal layers 45 and 48 constant. For example, a resin material or a glass material is used.

The sealing portion is an enclosing port for enclosing the liquid crystal, and thereafter, the liquid crystal is sealed from the outside.

In the liquid crystal dimming element 11, the alignment film 46 includes a polymer material, for example, polyimide, and an alignment direction of liquid crystal molecules is set by rubbing treatment performed in a predetermined direction in advance.

The liquid crystal layers 45 and 48 contain predetermined dye molecules (dichroic dye molecules) in addition to guest-host type (GH type) liquid crystal molecules. The GH type liquid crystal is classified into a negative type and a positive type depending on a difference in a long axis direction of liquid crystal molecules at the time of voltage application. For example, in the GH type liquid crystal of the positive type, the long axis direction of the liquid crystal molecules is perpendicular to the optical axis at the time of no voltage application (OFF state), and the long axis direction of the liquid crystal molecules is parallel to the optical axis at the time of voltage application (ON state).

Each of the two liquid crystal layers 45 and 48 of the liquid crystal dimming element 11 has upper and lower electrodes (transparent electrode films 44a and 44b and transparent electrode films 47a and 47b), and is driven by a total of four signals. That is, the positive electrode level and the negative electrode level of the liquid crystal drive signal SP1 and the positive electrode level and the negative electrode level of the liquid crystal drive signal SP2 are applied.

In the liquid crystal, alternating-current inversion is essential to ensure durability, and two-phase clocks are supplied to two electrodes of each of the liquid crystal layers 45 and 48. That is, for the liquid crystal drive signal SP1 that is a clock pulse of a certain frequency, the signal and the inverted signal are applied to the transparent electrode films 44a and 44b. Furthermore, similarly for the liquid crystal drive signal SP2 that is a clock pulse of a certain frequency, the signal and the inverted signal are applied to the transparent electrode films 47a and 47b.

The transmittance of the liquid crystal dimming element 11 to which the liquid crystal drive signals SP1 and SP2 having a certain frequency and amplitude are provided increases as the amplitude increases depending on the liquid crystal type. Alternatively, the transmittance decreases as the amplitude increases.

That is, the camera control unit 30 provides the dimming control signal SG1, which is an indication value of brightness, to the dimming drive circuit 32, and the dimming drive circuit 32 outputs the liquid crystal drive signals SP1 and SP2 having amplitudes according to the indication, so that the transmittance by the liquid crystal dimming element 11 is varied, and a dimming operation is executed.

### 3. Shading Correction

### 3-1: Shading by Liquid Crystal Dimming Element and Correction Coefficient Table

As described above, the imaging device 1 according to the present embodiment is an interchangeable lens camera. Then, the liquid crystal dimming element 11 is disposed in front of the imaging element 12 in the lens optical system of the imaging device 1 (camera body).

Shading exerted by the liquid crystal dimming element 11 on a captured image includes generation of a bright region and a dark region due to variation in the transmittance depending on the alignment of liquid crystal molecules.

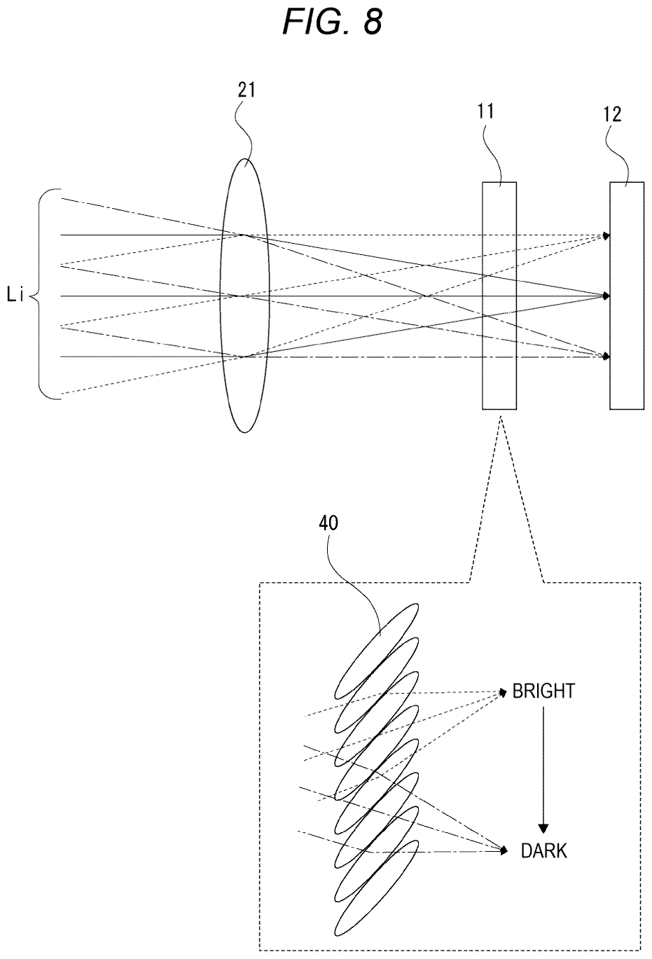

FIG. 8 schematically illustrates the lens system 21, the liquid crystal dimming element 11, and the imaging element 12, and the incident light Li of the captured image is indicated by a solid line, a broken line, and a one-dot chain line.

Furthermore, an alignment state of liquid crystal molecules 40 of the liquid crystal dimming element 11 is illustrated in the lower part of the drawing.

In the drawing, the liquid crystal molecules 40 are illustrated in a state in which the right side faces upward, and a description will be given assuming that the pixel in the upper part of the imaging element 12 corresponds to the upper part of the captured image surface in this state.

When the liquid crystal molecules 40 are in the state as illustrated in the drawing, an amount of light of an image corresponding to the upper part of a screen indicated by the broken line is larger than that at the lower part of the screen, and the image corresponding to the upper part is brighter. That is, in the captured image, shading occurs in which the upper part is brighter and the lower part is darker.

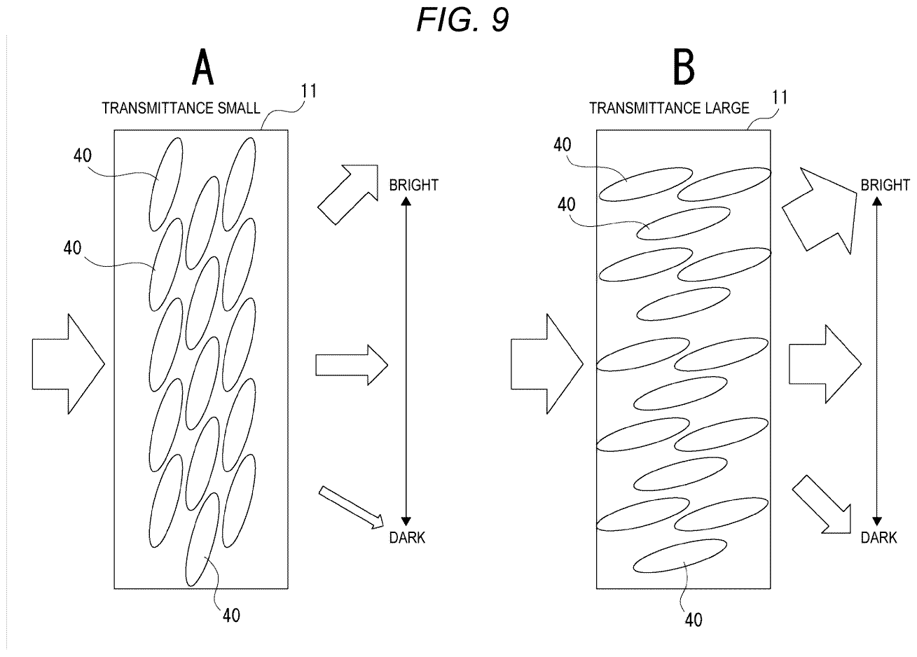

FIG. 9A schematically illustrates a state of the liquid crystal molecules 40 in a case where the transmittance of the liquid crystal dimming element 11 is decreased, and FIG. 9B schematically illustrates a state in a case where the transmittance is increased.

In both the state of FIG. 9A in which the amount of light is greatly reduced and the state of FIG. 9B in which the reduction width of the amount of light is small, in the state of the liquid crystal molecules 40, the right side faces upward in the drawing. That is, the direction of the liquid crystal molecules is controlled according to a desired transmittance within a range in which the right side faces upward in the drawing.

Then, in any transmittance, shading occurs in which the upper part of the captured image is brighter and the lower part is darker.

In other words, it can be said that directionality of brightness and darkness on the screen of the captured image does not change, and the degree of difference between brightness and darkness varies depending on the transmittance.

That is, when the alignment of the liquid crystal molecules 40 is specified, shading occurs in which the upper side of the screen is brighter and the lower side is darker, and thus, on the contrary, the pixel value on the upper side of the screen is corrected so that the screen is darker, and the pixel value on the lower side is corrected so that the screen is brighter, whereby shading can be corrected.

As a result of actual measurement with various lenses, it has been confirmed that the upper part of the screen is brighter and the lower part is darker in the case of having the alignment as illustrated in FIG. 8.

Note that, for example, in the state of FIG. 8, in a case where the alignment of the liquid crystal molecules 40 in the liquid crystal dimming element 11 is in a state in which the left side faces upward, on the contrary, the lower part of the screen is brighter and the upper part is darker.

Since it is obvious in design that the liquid crystal dimming element 11 and the imaging element 12 are mounted in the imaging device 1 in what posture relationship, the directionality of brightness and darkness of the shading appearing on the screen can be predicted in advance regardless of the directionality, and the correction coefficient for each pixel value of the captured image signal for that purpose can be set.

Meanwhile, in the optical system of the imaging device 1, an amount of transmission onto the imaging element 12 is determined by an angle between a light beam incident on the liquid crystal dimming element 11 and the liquid crystal molecules 40 that change depending on a voltage applied to the liquid crystal dimming element 11.

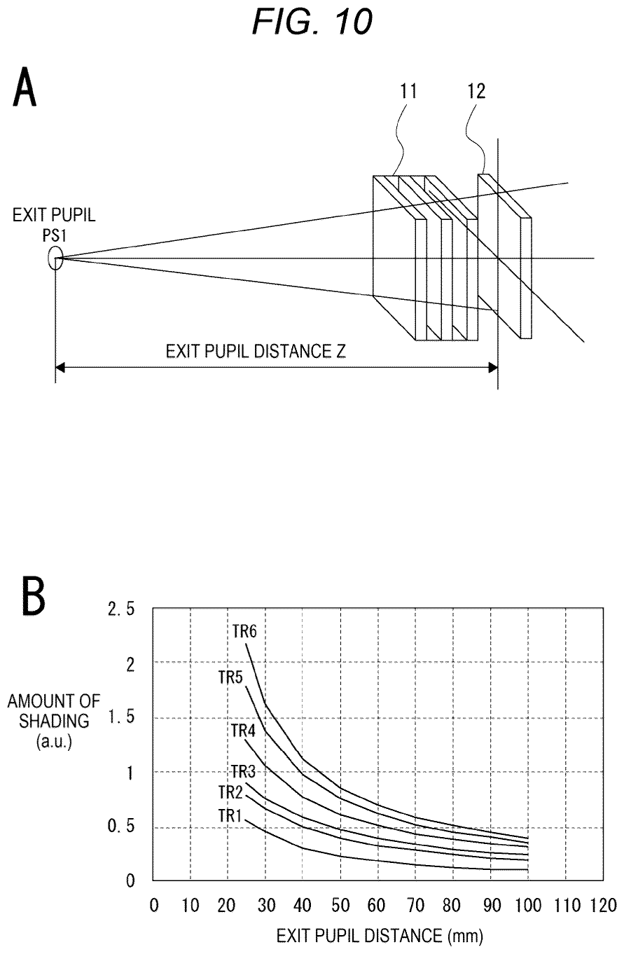

At this time, as illustrated in FIG. 10A, a point serving as a start point of the light beam is a position PS1 (exit pupil distance Z) of the exit pupil determined by the optical system from the lens to the imaging element 12 on the optical axis as the normal line on the plane of the liquid crystal dimming element 11. An amount of light incident on each point on the imaging surface of the imaging element 12 from the position PS1 through the liquid crystal dimming element 11 is calculated by the inner product of the angle between an incident light beam corresponding to each point and the liquid crystal molecules as described above.

An amount-of-light shading calculation value in an image on the imaging surface of the imaging element 12 created by such a principle actually matches the shading in the image output by the optical system under the same condition with a good correlation.

FIG. 10B illustrates characteristics in which the vertical axis represents the amount of shading and the horizontal axis represents the exit pupil distance. Each curve indicates a relationship between the exit pupil distance and the amount of shading in the case of different transmittances TR of the liquid crystal dimming element 11, in which the transmittances are TR1 to TR7.

As can be seen from the drawing, the amount of shading has a correlation with the exit pupil distance and the transmittance.

Thus, it is possible to obtain map data of shading to be corrected in a state of the exit pupil and the liquid crystal dimming element 11.

That is, since the amount of shading on the captured image can be grasped in combinations of the exit pupil distance 2 and the transmittance TR, a correction coefficient table for shading correction can be generated for each combination of the exit pupil distance Z and the transmittance TR.

An example of the correction coefficient table will be described.

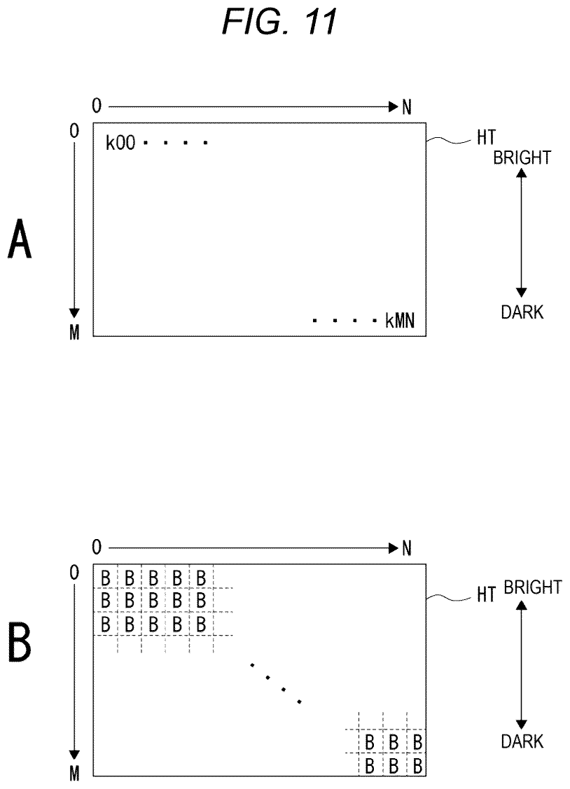

FIG. 11A illustrates one correction coefficient table HT. This example is a table having M×N correction coefficients (k00 to kMN) corresponding to each pixel when the number of pixels of one frame of the captured image signal is (M×N).

A correction coefficient k for each pixel in the correction coefficient table HT is a coefficient that decreases the pixel value (luminance value) at the upper part of the screen and increases the pixel value (luminance value) at the lower part of the screen for shading in which the upper part of the screen is brighter and the lower part of the screen is darker, for example.

FIG. 11B is an example of the correction coefficient table HT in which pixels on one screen are divided into blocks and a correction coefficient is set for each of blocks B. That is, this is an example in which correction coefficient values are the same for pixels in one block B.

Since the amount of shading is determined according to a position of the pixel as illustrated in FIG. 8, even if a certain number of pixels are made into a block, the correction accuracy does not decrease so much. Thus, as illustrated in FIG. 11B, the correction coefficient k may be set for each block B. This makes it possible to reduce the storage capacity required for the table and reduce the processing load. The size (number of pixels) of the block B can be variously considered.

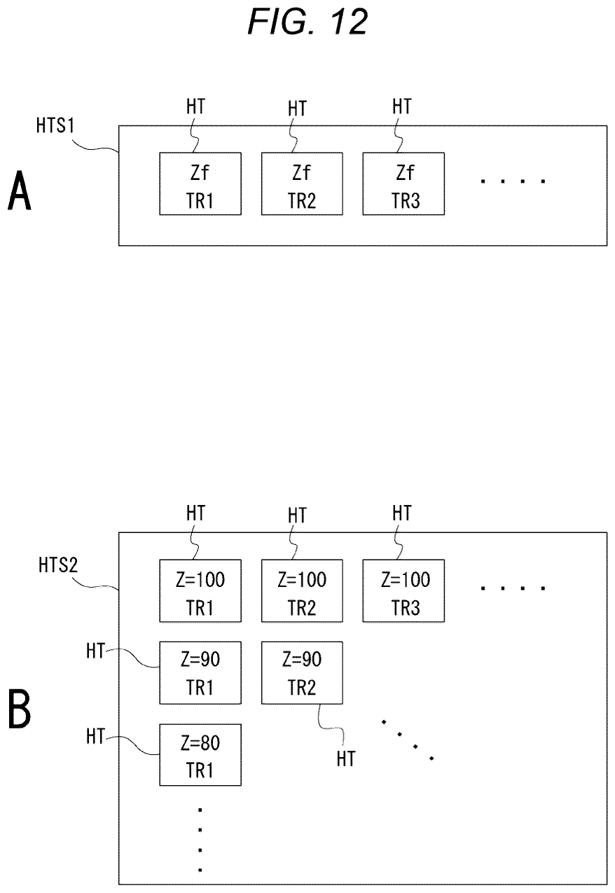

For example, as the correction coefficient table HT as illustrated in FIGS. 11A and 11B, a plurality of correction coefficient tables HT is provided by adjustment of a value of the correction coefficient for each combination of the exit pupil distance Z and the transmittance TR of the liquid crystal dimming element 11. The plurality of correction coefficient tables HT is a correction coefficient table group HTS1 of FIG. 12A or a correction coefficient table group HTS2 of FIG. 12B.

FIG. 12A illustrates an example of the correction coefficient table group HTS1 in which a representative value of the exit pupil distance Z is selected and set as an exit pupil distance Zf as a fixed value, and a plurality of correction coefficient tables HT is provided by combination of the exit pupil distance Zf and the transmittance TR.

For example, a fixed value exit pupil distance Zf=50 mm is set, and a correction coefficient table HT is provided that stores a correction coefficient for each pixel (or each block B) for each of transmittances TR1, TR2, . . . TR6 at the exit pupil distance=50 mm in FIG. 10B.

Such a correction coefficient table group HTS1 in FIG. 12A is an example used in processing in a first embodiment described later.

FIG. 12B illustrates an example of the correction coefficient table group HTS2 in which the correction coefficient table HT is provided for each combination of the exit pupil distance Z and the transmittance TR.

For example, for the exit pupil distance Z=100 mm, the correction coefficient table HT is prepared corresponding to each case of the transmittances TR1, TR2, TR3, . . .

Moreover, similarly, in each case where the exit pupil distance Z is 90 mm, 80 mm. the correction coefficient table HT is prepared for each transmittance TR.

Note that it is not realistic to provide the correction coefficient table HT for all combinations of the exit pupil distance Z and the transmittance TR. For example, when the correction coefficient table HT is prepared by combinations of the exit pupil distances Z=100 mm, 99 mm, 98 mm . . . , and the transmittances TR=100%, 99%, 98% . . . , the number of correction coefficient. tables HT is enormous.

Thus, for example, as illustrated in FIG. 12B, a combination is set for each of certain points for each of the exit pupil distances Z and the transmittances TR to prepare the correction coefficient table HT. In the case of a situation not corresponding to the combination, it is only required to generate the correction coefficient k by interpolation processing.

For example, in a case where the transmittance TR1 and the exit pupil distance Z=95 mm, the correction coefficient table HT of (Z=100 mm/TR1) and the correction coefficient table HT of (Z=90 mm/TR1) are used, and each correction coefficient k is generated by interpolation processing from the correction coefficient values stored in the two correction coefficient tables HT.

This similarly applies to the correction coefficient table group HTS1 of FIG. 12A, and it is only required to prepare the correction coefficient table HT according to a certain number of discrete transmittances TR and generate the correction coefficients k corresponding to the other transmittances TR by interpolation processing.

Note that the correction coefficient table HT may be a table that actually stores the correction coefficient k for each pixel or block B, or may be stored as a calculation expression for obtaining the correction coefficient k by predetermined calculation processing. That is, any form of information may be used as long as it is information by which the correction coefficient k is obtained corresponding to each pixel according to the relationship between the exit pupil distance Z and the transmittance TR.

### 3-2: Functional Configuration for Shading Correction

A shading correction operation according to the present embodiment will be described below.

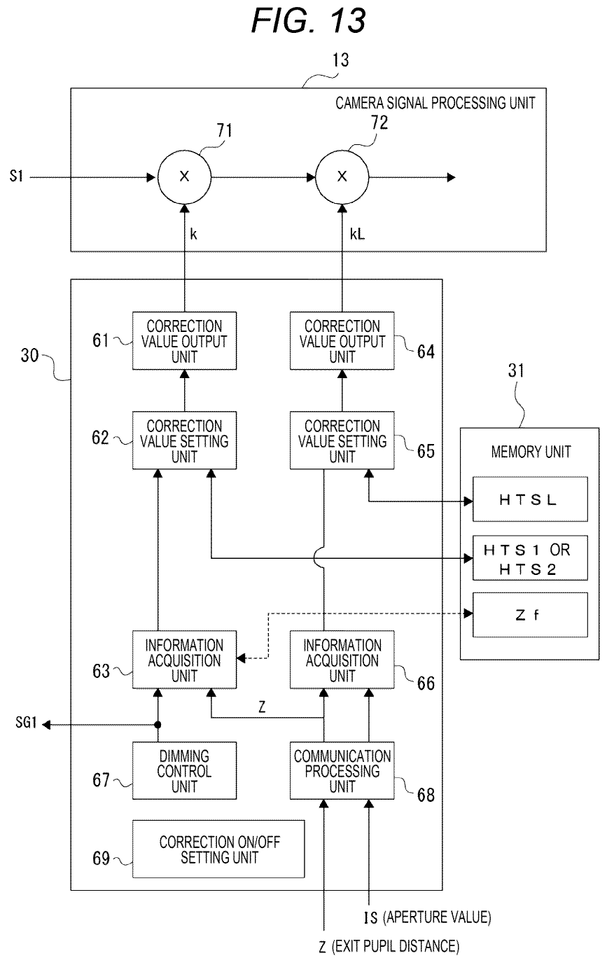

FIG. 13 illustrates a configuration for shading correction in the camera signal processing unit 13 and a functional configuration for shading correction in the camera control unit 30.

The camera signal processing unit 13 includes a coefficient multiplier 71 for correcting shading caused by the liquid crystal dimming element 11 with respect to a captured image signal S1, and a coefficient multiplier 72 for correcting shading caused by the lens system 21 on the lens barrel 2 side.

The coefficient multipliers 71 and 72 multiply the pixel values of the captured image signal S1 by the correction coefficients k and kL.

Note that the correction coefficient k is a correction coefficient for each pixel supplied to the camera signal processing unit 13 on the basis of the correction coefficient table HT prepared for shading correction corresponding to the liquid crystal dimming element 11 as illustrated in FIG. 12A or 12B.

Although not described in detail, the correction coefficient kL is a correction coefficient for each pixel supplied to the camera signal processing unit 13 on the basis of a correction coefficient table prepared for shading correction corresponding to the lens system 21.

The coefficient multipliers 71 and 72 are implemented as one multiplication procedure in a signal processing process in the DSP as the camera signal processing unit 13, for example, but may be formed by a multiplier as hardware.

In the camera control unit 30, as functions for shading correction corresponding to the liquid crystal dimming element 11, a correction value output unit 61, a correction value setting unit 62, and an information acquisition unit 63 are provided as calculation procedures by software, for example.

Furthermore, in the camera control unit 30, as functions for shading correction corresponding to the lens system 21, a correction value output unit 64, a correction value setting unit 65, and an information acquisition unit 66 are provided as calculation procedures by software, for example.

Furthermore, in the camera control unit 30, a communication processing unit 68 that controls communication with the lens barrel 2 via the communication unit 34 is provided as a function implemented by software, for example.

Furthermore, in the camera control unit 30, a dimming control unit 67 that outputs the dimming control signal SG1 indicating a brightness level for the dimming drive circuit 32 is provided as a function implemented by software, for example.

Furthermore, in the camera control unit 30, a correction ON/OFF setting unit 69 that sets whether to execute shading correction processing (correction ON) or not to execute the shading correction processing (correction OFF) is provided as a function implemented by software, for example.

The memory unit 31 stores a correction coefficient table group.

In this example, it is assumed that stored are a correction coefficient table group HISL for shading correction corresponding to the lens system 21 and a correction coefficient table group for shading correction Corresponding to the liquid crystal dimming element 11. The correction coefficient table group for shading correction corresponding to the liquid crystal dimming element 11 is the correction coefficient table group HTS1 in FIG. 12A or the correction coefficient table group HTS2 in FIG. 12B.

Furthermore, the memory unit 31 may store a value of the exit pupil distance Zf as a fixed value. In a case where the correction coefficient table group of FIG. 12B is used in processing examples of second and third embodiments described later, a certain value is stored as the exit pupil distance Zf.

Note that, in a case where the correction coefficient table group HTS1 of FIG. 12A is used in a processing example of the first embodiment described later, it is not necessary to store the value of the exit pupil distance Zf in the memory unit 31.

As a function for shading correction corresponding to the liquid crystal dimming element 11, the information acquisition unit 63 acquires information of the transmittance TR and information of the exit pupil distance Z (or Zf).

The camera control unit 30 itself indicates the transmittance TR of the liquid crystal dimming element 11 by the dimming control signal SG1 by the function of the dimming control unit 67. Thus, the information acquisition unit 63 can grasp the current transmittance TR of the liquid crystal dimming element 11 by sequentially confirming the dimming control signal SG1.

In the processing example of the first embodiment described later, the information acquisition unit 63 does not need to acquire the exit pupil distance Z or Zf. It. is only required to acquire only the transmittance TR.

In the processing examples of the second and third embodiments, the information acquisition unit 63 may acquire the information of the exit pupil distance Z from the communication processing unit 68. The communication processing unit 68 sequentially executes the communication by the communication unit 34, so that the information of the current exit pupil distance Z can be acquired from the lens barrel 2. Furthermore, the information acquisition unit 63 may acquire information of the exit pupil distance Zf as a fixed value from the memory unit. 31.

The correction value setting unit 62 performs processing of setting a correction value according to the information of the transmittance TR acquired by the information acquisition unit 63. The correction value may be set by use of the exit pupil distance Z (or Zf).

For example, the correction value setting unit 62 selects a correction coefficient table HT in a correction coefficient table group HTS stored in the memory unit 31, and acquires the correction coefficient k of each pixel in the correction coefficient table HT. Alternatively, as described above, the interpolation processing is performed using the correction coefficients k of the plurality of correction coefficient tables HT, and the correction coefficient k of each pixel according to the current transmittance TR or the like is generated.

The correction value output unit 61 sequentially supplies the correction coefficient set by the correction value setting unit 62, for example, the correction coefficient k for each pixel of one frame, to the camera signal processing unit 13 in accordance with a timing of the captured image signal S1, and causes the coefficient multiplier 71 to execute multiplication processing.

The correction ON/OFF setting unit 69 is a function of setting whether or not to execute the shading correction processing.

According to the state of the imaging device 1, the state of the lens, the user setting, and the like, it is determined whether or not to execute the processing of the information acquisition unit 63, the correction value setting unit 62, and the correction value output unit 61.

### 3-3: Processing Example as First Embodiment

A processing example of the camera control unit 30 implemented by these functions will be described.

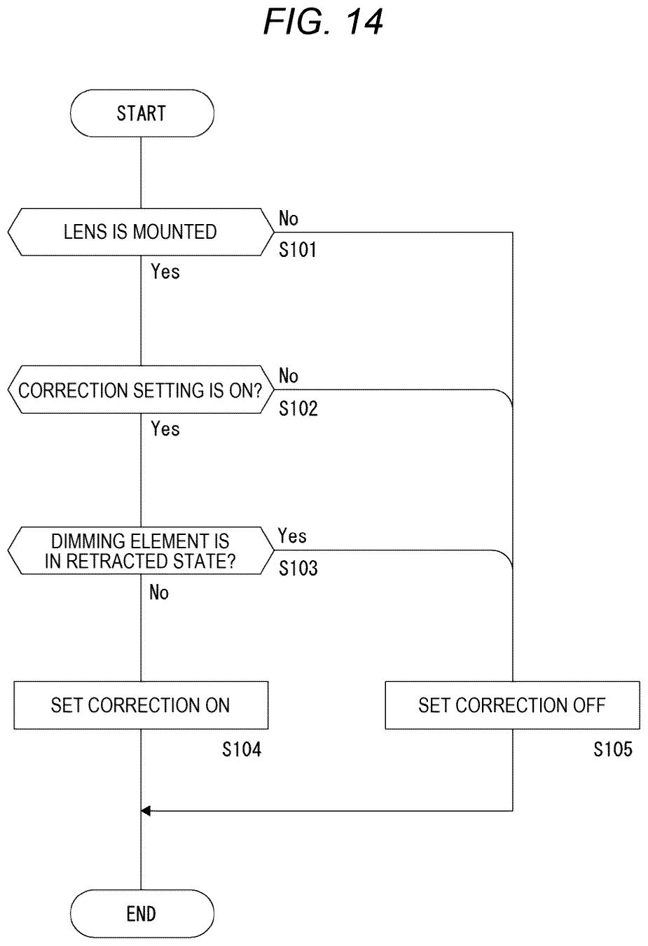

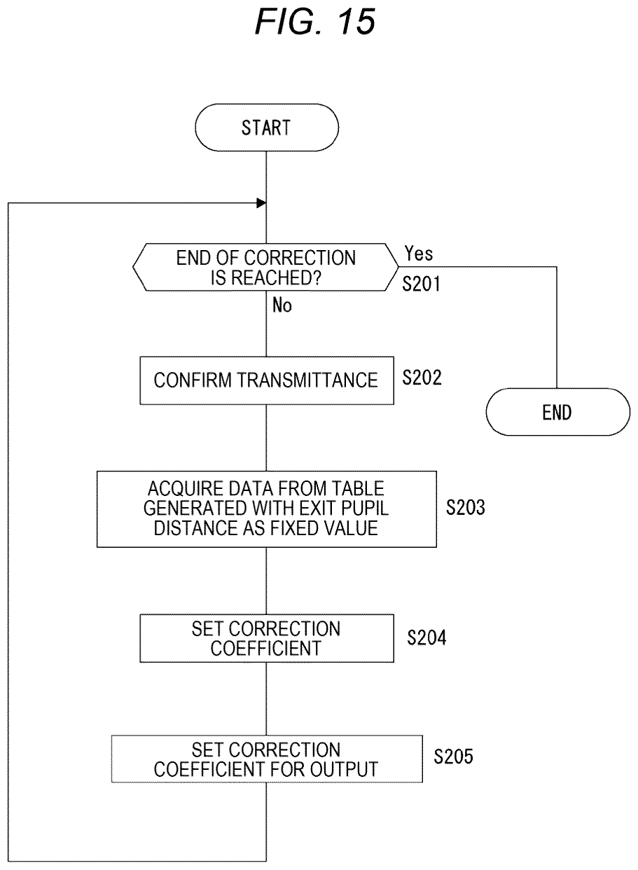

A processing example as the first embodiment will be described with reference to FIGS. 14 and 15. FIG. 14 illustrates an example of correction ON/OFF setting processing by a function of the correction ON/OFF setting unit 69 of the camera control unit 30, and FIG. 15 illustrates an example of correction coefficient setting processing mainly by functions of the information acquisition unit 63, the correction value setting unit 62, and the correction value output unit 61 of the camera control unit 30.

In step S101 of FIG. 14, the camera control unit 30 determines whether or not the lens barrel 2 is mounted. In a case where the lens barrel 2 is not mounted, imaging is not performed, and thus the camera control unit 30 sets shading correction OFF in step S105.

In a case where the lens barrel 2 is mounted, the camera control unit 30 proceeds to step S102, and confirms whether or not correction setting is ON. This is confirmation of user setting for the imaging device 1, and is processing of confirming which of ON/OFF is selected by the user for the shading correction processing by menu operation or the like, for example. If the correction setting by the user is OFF, the camera control unit 30 sets shading correction OFF in step S105.

When the correction setting is ON, the camera control unit 30 proceeds to step S103, and confirms whether or not the liquid crystal dimming element 11 is currently in the retracted state in FIG. 4A. If it is in the retracted state, the shading correction processing caused by the liquid crystal dimming element 11 is unnecessary, and thus the camera control unit 30 sets shading correction OFF in step S105.

If the liquid crystal dimming element 11 is not in the retracted state, the camera control unit 30 proceeds to step S104 and sets shading correction ON.

The camera control unit 30 sequentially performs the processing of FIG. 14 to set whether or not to execute the shading correction processing.

When shading correction ON is set, the camera control unit 30 executes the processing of FIG. 15 in response to a start of imaging a moving image or a still image, for example. The start of imaging here may be, for example, a case where through image display is started in a standby state of moving image capturing or still image capturing, or may be a case where recording of a moving image is actually started. Alternatively, it may be when a shutter operation as still image recording is performed.

Note that, in the first embodiment, it is assumed that the correction coefficient table group HTS1 is stored in the memory unit 31. The exit pupil distance Zf does not have to be stored.

In step S201, it is determined whether or not an end of correction is reached. The end of correction is, for example, a case where imaging ends after the start of imaging described above, or a case where shading correction OFF is set in the processing of FIG. 14 even during imaging. When the end of correction is reached, the camera control unit 30 ends the processing of FIG. 15.

Until it is determined that the end of correction is reached, the camera control unit 30 repeatedly executes the processing from step S202 to step S205.

In step S202, the camera control unit 30 confirms the current transmittance of the liquid crystal dimming element 11. For this, it is only required to confirm the indication value of the latest dimming control signal SG1.

In step S203, the camera control unit 30 refers to the correction coefficient table HT corresponding to the current transmittance in the correction coefficient table group HTS1 in FIG. 12A. That is, the table is a table in which a correction coefficient is set assuming a fixed exit pupil distance Zf.

Note that, if there is no correction coefficient table HT corresponding to the current transmittance TR, the correction coefficient table HT of the transmittances before and after the current transmittance TR is referred to.

In step S204, the camera control unit 30 sets a correction coefficient k (k00 to kMN) for each pixel value of the captured image signal S1.

Specifically, in a case where the correction coefficient table HT corresponding to the current transmittance TR is referred to, the camera control unit 30 reads a correction coefficient stored for each pixel or each block B in the correction coefficient table HT, and sets the read correction coefficient as the correction coefficient k for each pixel.

Furthermore, in a case where there is no correction coefficient table HT corresponding to the current transmittance TR and the correction coefficient tables HT of the transmittances before and after the current transmittance TR are referred to, the camera control unit 30 performs interpolation calculation from data of the two correction coefficient tables HT, and calculates the correction coefficient k of each pixel corresponding to the current transmittance TR.

In step S205, the camera control unit 30 sets the set correction coefficient k as a correction coefficient to be output to the camera signal processing unit 13. The correction coefficient k (k00 to kMN) is supplied to the camera signal processing unit 13 at a predetermined timing.

In the camera control unit 30, the shading correction processing by the coefficient multiplier 71 is executed for each frame with the correction coefficient k set in the above correction coefficient setting processing.

Note that the correction coefficient setting processing of FIG. 15 may be performed at each frame timing, or may be performed, for example, at a timing when a change in transmittance of the liquid crystal dimming element 11 is detected to update the correction coefficient k.

### 3-4: Processing Example as Second Embodiment

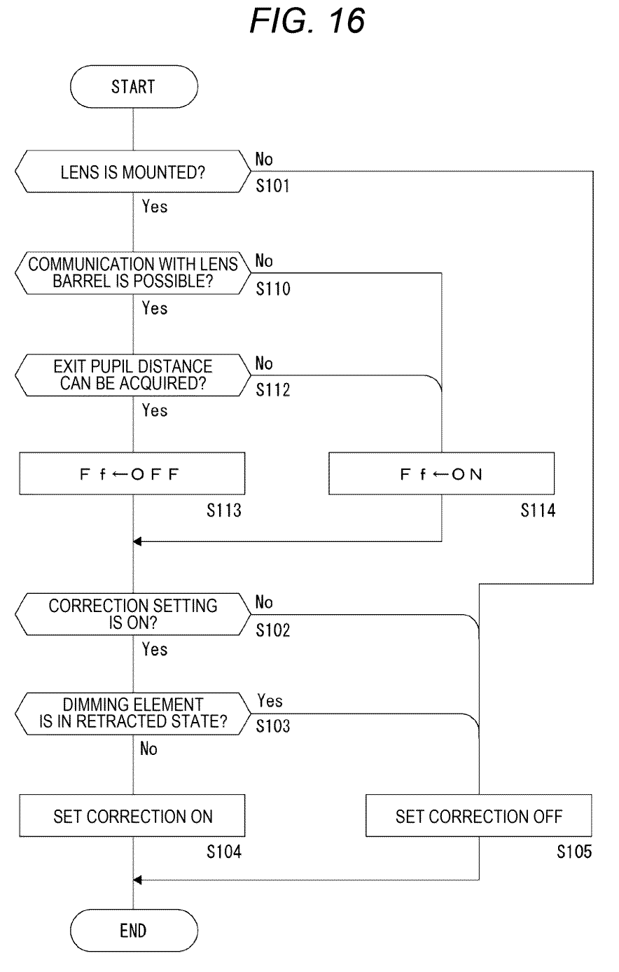

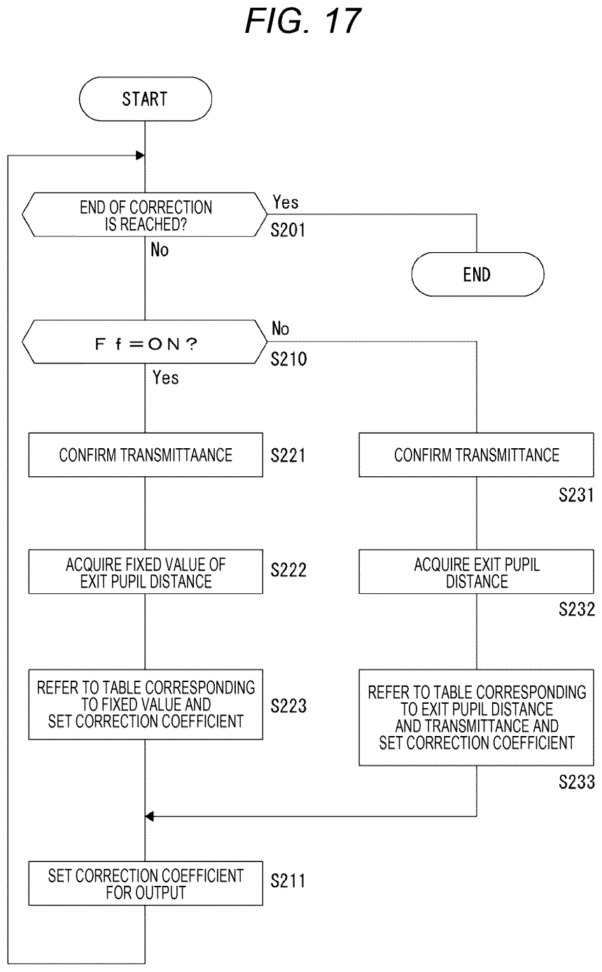

A processing example of the second embodiment will be described with reference to FIGS. 16 and 17. FIG. 16 illustrates an example of correction ON/OFF setting processing by the function of the correction ON/OFF setting unit 69 of the camera control unit 30, and FIG. 17 illustrates an example of correction coefficient setting processing by the functions of the information acquisition unit 63, the correction value setting unit 62, the correction value output unit 61, and the communication processing unit 68 of the camera control unit 30.

In step S101 of FIG. 16, the camera control unit 30 determines whether or not the lens barrel 2 is mounted. In a case where the lens barrel 2 is not mounted, imaging is not performed, and thus the camera control unit 30 sets shading correction OFF in step S105.

In a case where the lens barrel 2 is mounted, the camera control unit 30 proceeds to step S110 and determines whether or not communication with lens barrel 2 is possible.

In a case where the mounted lens barrel 2 is an incommunicable model, the camera control unit 30 proceeds to step S114 and sets a fixed value application flag Ff to ON.

In a case where the mounted lens barrel 2 is a communicable model, the camera control unit 30 proceeds to step S112 and determines whether or not the value of the exit pupil distance Z can be acquired by communication. This is because some models of the lens barrel 2 do not transmit the value of the exit pupil distance even when communicating with imaging device 1.

In a case where the mounted lens barrel 2 is a model that does not transmit the value of the exit pupil distance Z, the camera control unit 30 proceeds to step S114 and sets the fixed value application flag Ff to ON.

In a case where the mounted lens barrel 2 is a model that transmits the value of the exit pupil distance Z, the camera control unit 30 proceeds to step S113 and sets the fixed value application flag Ff to OFF.

In step S102, the camera control unit 30 confirms whether or not the correction setting by the user is ON. If the correction setting by the user is OFF, the camera control unit 30 sets shading correction OFF in step S105.

When the correction setting by the user is ON, the camera control unit 30 proceeds to step S103 and confirms whether or not the liquid crystal dimming element 11 is currently in the retracted state. The camera control unit 30 sets shading correction OFF in step S105 if the liquid crystal dimming element 11 is in the retracted state, and sets shading correction ON in step S104 if the liquid crystal dimming element 11 is not in the retracted state.

The camera control unit 30 sequentially performs the processing of FIG. 16 to set whether or not to execute the shading correction processing.

When shading correction ON is set, the camera control unit 30 executes the processing of FIG. 17 in response to a start of imaging a moving image or a still image, for example.

Note that in the second embodiment, it is assumed that the memory unit 31 stores the correction coefficient table group HTS2, and the exit pupil distance Zf as a fixed value.

In step S201, the camera control unit 30 determines whether or not an end of correction is reached. When the end of correction is reached, the camera control unit 30 ends the processing of FIG. 17.

The meaning of the start of imaging and the meaning of the end of correction here are similar to those in the case of FIG. 15.

Until it is determined that the end of correction is reached, the camera control unit 30 repeatedly executes the processing from step S210 to step S211.

In step S210, the camera control unit 30 causes the processing to branch depending on whether the fixed value application flag Ff is ON or OFF.

When the fixed value application flag Ff is ON, the camera control unit 30 executes first processing (steps S221 to S223).

First, the camera control unit 30 proceeds to step S221 and confirms the current transmittance of the liquid crystal dimming element 11.

In step S222, the camera control unit 30 reads the value of the exit pupil distance Zf as a fixed value stored in the memory unit 31.

In step S223, the camera control unit 30 sets a correction coefficient k (k00 to kMN) for each pixel value of the captured image signal S1.

In this case, in the correction coefficient table group HTS2 of FIG. 12B, the correction coefficient table HT corresponding to the value of the exit pupil distance Zf and the current transmittance are referred to.

Note that the exit pupil distance Zf is set such that there is a correction coefficient table corresponding to the exit pupil distance in the correction coefficient table group HTS2, whereby there is a plurality of correction coefficient tables HT corresponding to the exit pupil distance Zf. Thus, it is only required to refer to the correction coefficient table HT corresponding to the transmittance TR among them.

However, if there is no correction coefficient table HT corresponding to the current transmittance among the plurality of correction coefficient tables HT corresponding to the exit pupil distance Zf, the correction coefficient table HT of the transmittances before and after the current transmittance TR is referred to.

Then, in a case where the correction coefficient table HT corresponding to the exit pupil distance Zf and the transmittance TR is referred to, the camera control unit 30 reads a correction coefficient stored for each pixel or each block B in the correction coefficient table HT, and sets the read correction coefficient as the correction coefficient for each pixel.

Furthermore, in a case where there is no correction coefficient table HT corresponding to the transmittance TR in the correction coefficient table HT corresponding to the exit pupil distance Zf, and the correction coefficient tables HT of the transmittances before and after the transmittance TR are referred to, the camera control unit 30 performs interpolation calculation from data of the two correction coefficient tables HT, and calculates a correction coefficient of each pixel Corresponding to the current transmittance TR.

Then, in step S211, the camera control unit 30 sets the set correction coefficient k as a correction coefficient to be output to the camera signal processing unit 13. The correction coefficient k (k00 to kMN) is supplied to the camera signal processing unit 13 at a predetermined timing.

When the fixed value application flag Ff is OFF, the camera control unit 30 executes second processing (steps S231 to S233).

That is, the camera control unit 30 proceeds from step S210 to step S231, and confirms the current transmittance TR of the liquid crystal dimming element 11.

In step S232, the camera control unit 30 causes the communication unit 34 to communicate with the lens barrel 2. Then, information of the exit pupil distance Z is received as a communication result.

In step S233, the camera control unit 30 sets a correction coefficient k (k00 to kMN) for each pixel value of the captured image signal S1.

In this case, the correction coefficient table HT Corresponding to the value of the exit pupil distance Z and the current transmittance TR is referred to in the correction coefficient table group HTS2 of FIG. 12B.

Note that there may be a case where there is no correction coefficient table HT corresponding to the current exit pupil distance Z and there is a correction coefficient table HT corresponding to the current transmittance TR. In this case, it is possible to perform interpolation calculation using two correction coefficient tables HT corresponding to the exit pupil distances before and after the exit pupil distance Z among the plurality of correction coefficient tables HT corresponding to the transmittance TR, to obtain the correction coefficient k.

Furthermore, there may be a case where there is a correction coefficient table HT corresponding to the current exit pupil distance Z and there is no correction coefficient table HT corresponding to the current transmittance TR. In this case, it is possible to perform interpolation calculation using two correction coefficient tables HT corresponding to the transmittances before and after the current transmittance TR among the plurality of correction coefficient tables HT Corresponding to the exit pupil distance Z, to obtain the correction coefficient k.

There may be a case where there is no correction coefficient table HT corresponding to the exit pupil distance Z and there is no correction coefficient table HT corresponding to the current transmittance TR. In this case, for example, interpolation calculation is performed from a table group corresponding to the exit pupil distances before and after the exit pupil distance Z, and a new interpolation table group is generated. Then, it is possible to perform interpolation calculation using two interpolation tables corresponding to the transmittances before and after the current transmittance in the interpolation table group, to obtain the correction coefficient k.

Then, in step S211, the camera control unit 30 sets the set correction coefficient k as a correction coefficient to be output to the camera signal processing unit 13. The correction coefficient k (k00 to kMN) is supplied to the camera signal processing unit 13 at a predetermined timing.

In the camera control unit 30, the shading correction processing by the coefficient multiplier 71 is executed for each frame with the correction coefficient k set in the above correction coefficient setting processing.

Note that the correction coefficient setting processing of FIG. 17 may be performed at each frame timing, or may be processing executed, for example, at a timing when there is a possibility of a change in transmittance of the liquid crystal dimming element 11 or a change in the exit pupil distance Z to update the correction coefficient k.

### 3-5: Processing Example as Third Embodiment

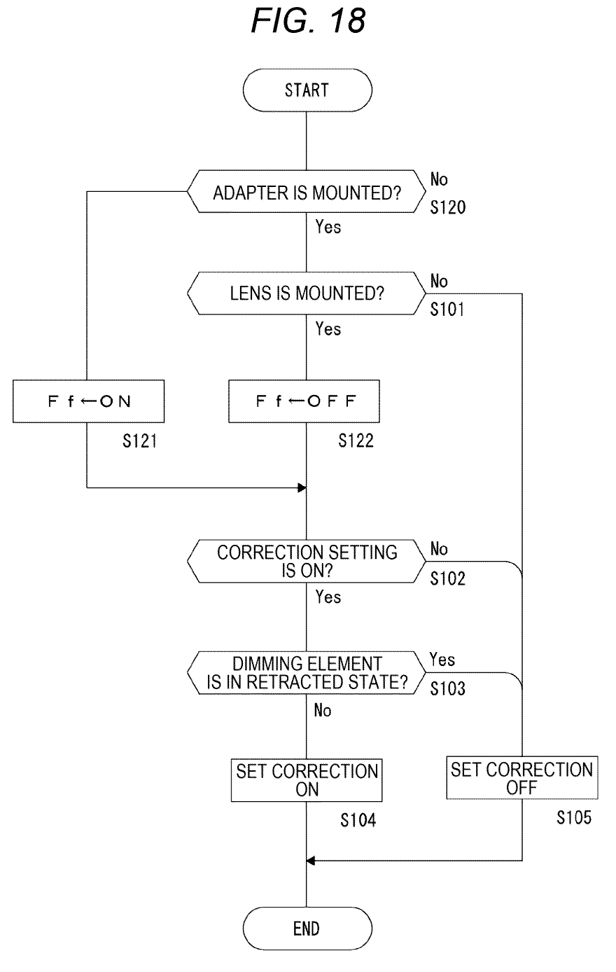

FIG. 18 illustrates a processing example of correction ON/OFF setting in the third embodiment.

Note that, in the third embodiment, the correction coefficient setting processing is similar to that in FIG. 17.

In step S120 of FIG. 18, the camera control unit 30 determines whether or not the adapter 70 is mounted.

In a state in which the adapter 70 is mounted, the camera control unit 30 determines that the lens barrel 2 mounted with the adapter 70 interposed therebetween is an interchangeable lens from which the exit pupil distance Z cannot be acquired, and proceeds to step S121 to set the fixed value application flag Ff to ON.

In a case where the adapter 70 is not mounted, the camera control unit 30 determines in step S101 whether or not the lens barrel 2 is mounted. In a case where the lens barrel 2 is not mounted, the camera control unit 30 sets shading correction OFF in step S105.

In a case where the lens barrel 2 is mounted without the adapter 70, it can be estimated that the lens barrel 2 is an interchangeable lens from which the exit pupil distance Z can be acquired by communication. Thus, the camera control unit 30 sets the fixed value application flag Ff to OFF in step S122.

Subsequent steps S102 to S105 are similar to those in FIG. 16.

In the third embodiment, ON/OFF of the fixed value application flag Ff is set by mounting of the adapter 70, and the first processing (steps S221 to S223) or the second processing (steps S231 to S233) in FIG. 17 is selected accordingly.

The processing is simplified by setting of the fixed value application flag Ff according to the presence or absence of mounting of the adapter 70.

### 3-6: Shading Correction Corresponding to Lens System

Meanwhile, substantially similar shading correction operation is also performed as shading correction caused by the lens system 21. The amount of shading caused by the lens system 21 has a correlation with the exit pupil distance Z and an aperture value IS of the aperture mechanism.

Thus, the information acquisition unit 66 acquires information of the aperture value IS and the exit pupil distance Z by communication with the lens barrel 2.

The correction value setting unit 65 performs processing of setting a correction value according to the information of the exit pupil distance Z and the aperture value IS acquired by the information acquisition unit 66.

For example, a correction coefficient table corresponding to a combination of the exit pupil distance Z and the aperture value IS is specified in the correction coefficient table group HTSL stored in the memory unit 31, and a correction coefficient of each pixel in the correction coefficient table is acquired. Alternatively, interpolation processing is performed to generate a correction coefficient of each pixel.

The correction value output unit 64 supplies the correction coefficient set by the correction value setting unit 65, for example, the correction coefficient KL for each pixel of one frame to the camera signal processing unit 13, and causes the coefficient multiplier 72 to execute multiplication processing.

By also correcting shading caused by the lens system 21 in this manner, it is possible to obtain a captured image in which influence of shading including shading caused by the liquid crystal dimming element 11 is eliminated or reduced, and to achieve high quality of the captured image.

Note that, in a case where the information of the aperture value IS and the exit pupil distance Z cannot be obtained from the lens barrel 2, it is conceivable that shading correction corresponding to shading caused by such a lens system 21 is not performed.

### 4. Summary and Modification

In the above embodiments, the following effects can be obtained.

The imaging device 1 according to the embodiments includes the mount portion 80 on which the lens barrel 2 as an interchangeable lens is mounted, the liquid crystal dimming element 11 that performs dimming of the incident light Li incident through the lens system 21 in the lens barrel 2 when the lens barrel 2 is mounted on the mount portion 80, and the imaging element 12 that photoelectrically converts incident light through the liquid crystal dimming element 11 to generate a captured image signal. Furthermore, the imaging device 1 includes the camera signal processing unit 13 that performs signal processing on the captured image signal S1 output from the imaging element 12, and the camera control unit 30. The camera control unit 30 performs control to cause the camera signal processing unit 13 to execute shading correction processing of correcting shading caused by the liquid crystal dimming element 11 with the correction coefficient k set on the basis of the characteristic of the inclination of the liquid crystal of the liquid crystal dimming element 11.

As a result, even in a state in which the lens barrel 2 from which the exit pupil distance Z cannot be acquired is mounted, since the correction coefficient k is set on the basis of the characteristic of the inclination of the liquid crystal of the liquid crystal dimming element 11, shading correction caused by the liquid crystal dimming element 11 can be executed, and the quality of the captured image can be improved.

In the processing examples of the first, second, and third embodiments, the camera control unit 30 uses the value corresponding to the transmittance TR of the liquid crystal dimming element 11, and the value of the exit pupil distance Zf as a fixed value determined in advance for determination of the correction coefficient k indicated, for the camera signal processing unit 13.

Since the amount of shading has a correlation with the exit pupil distance, and the transmittance of the liquid crystal dimming element 11, an appropriate correction coefficient can be obtained from the transmittance TR at the time of correction and the exit pupil distance Z. Here, in a situation where the information of the exit pupil distance Z cannot be obtained from the lens barrel 2, the exit pupil distance Zf, which is a fixed value, is used to cope with the situation. The correction coefficient is obtained according to the transmittance TR, and it is possible to perform correction to reduce shading by obtaining the coefficient according to characteristics of brightness and darkness on the image due to the inclination of the liquid crystal.

Note that the value corresponding to the transmittance TR indicates the transmittance TR itself or a value with which the transmittance TR can be determined, and includes, for example, the dimming control signal SG1 described in FIG. 13, and the like.

In the processing example of the first embodiment, the imaging device 1 includes the memory unit 31 that stores the correction coefficient table HT that stores the correction coefficient k for each pixel value of the captured image signal for each of a plurality of transmittances of the liquid crystal dimming element 11 with respect to the value of the exit pupil distance Zf as a fixed value determined in advance. Then, an example has been described in which the camera control unit 30 refers to the correction coefficient table HT Corresponding to the current transmittance TR and sets the correction coefficient k of the shading correction processing.

For example, the correction coefficient table HT corresponding to the case of a plurality of transmittances TR1, TR2, . . . is provided at the exit pupil distance Zf that is a fixed value as illustrated in FIG. 12A.

Since the shading density varies depending on the transmittance of the liquid crystal dimming element 11, even in a case where the fixed exit pupil distance Zf is assumed, it is possible to perform accurate shading correction processing by acquiring the correction coefficient from the correction coefficient table reflecting the transmittances TRI, TR2, . . .

Furthermore, as illustrated in FIG. 15, in the case of the processing always using the correction coefficient table HT of FIG. 12A, it is not necessary to provide the correction coefficient table for each exit pupil distance, so that the storage capacity necessary for storing the correction coefficient table HT can be reduced.

Note that the correction coefficient table HT Corresponding to the current transmittance is the correction coefficient table HT for a transmittance corresponding to the current transmittance, or, in a case where there is no correction coefficient table HT corresponding to the transmittance, is, for example, the correction coefficient table HT for transmittances before and after the current transmittance. That is, the table is the correction coefficient table HT to be referred to for setting the correction coefficient k.

In the processing examples of the second and third embodiments, an example has been described in which the camera control unit 30 selectively performs the first processing of determining the correction coefficient k by using the exit pupil distance Zf as a fixed value determined in advance and the value corresponding to the transmittance of the liquid crystal dimming element 11, and the second processing of determining the correction coefficient k by using the exit pupil distance Z received from the lens barrel 2 mounted on the mount portion 80 and the value corresponding to the transmittance of the liquid crystal dimming element 11, for determination of the correction coefficient k to be indicated for the camera signal processing unit 13.

For example, in a situation where the value of the exit pupil distance cannot be acquired by communication with the lens barrel 2 as in the processing of FIG. 17, in steps S221, S222, and S223, the correction coefficient table corresponding to the exit pupil distance Zf that is a fixed value and the transmittance is referred to and the correction coefficient is set (first processing). On the other hand, in a situation where the value of the exit pupil distance can be acquired by communication with the lens barrel 2, in steps S231, S232, and S233, the corresponding correction coefficient table is referred to and the correction coefficient is set (second processing).

As a result, while appropriate shading correction to some extent can be executed by the first processing even in a situation where the exit pupil distance cannot be acquired, more accurate shading correction can be performed by the second processing in a case where the exit pupil distance can be acquired.

In the second and third embodiments, the memory unit 31 stores the correction coefficient table HT that stores the correction coefficient k for each pixel value of the captured image signal for each of the plurality of transmittances of the liquid crystal dimming element 11 with respect to a plurality of values of the exit pupil distance Z including the exit pupil distance Zf as a fixed value. Then, in the first processing, the camera control unit 30 refers to the correction coefficient table HT corresponding to the exit pupil distance Zf set as a fixed value and the current transmittance, and sets the correction coefficient k. In the second processing, the camera control unit 30 refers to the correction coefficient table HT corresponding to the exit pupil distance Z received from the lens barrel 2 and the current transmittance, and sets the correction coefficient k.

For example, as illustrated in FIG. 12B, by including the correction coefficient table HT that stores the correction coefficient for each pixel value of the captured image signal S1 for each of the plurality of exit pupil distances Z and the plurality of transmittances, it is possible to acquire the correction coefficient for each pixel from the correction coefficient table HT even in a case where the exit pupil distance Z can be acquired or in a case where the exit pupil distance Z cannot be acquired and the fixed value exit pupil distance Zf is used, and the processing becomes easy.

Note that the correction coefficient table HT corresponding to the exit pupil distance Z and the current transmittance is the correction coefficient table HT corresponding to the exit pupil distance Z and the transmittance, or the correction coefficient table HT to be referred to for the interpolation processing in a case where there is no corresponding correction coefficient table HT. That is, the table is the correction coefficient table HT to be referred to for setting the correction coefficient k.

In the second embodiment, in a case where communication with the lens barrel 2 mounted on the mount portion 80 is not executable, the camera control unit 30 selects the first processing (see steps S110 and S114 in FIG. 16 and step S210 in FIG. 17).

Since the value of the exit pupil distance Z cannot be acquired in a case where the mounted lens barrel 2 is an incommunicable interchangeable lens, the correction coefficient is set according to the exit pupil distance Zf that is a fixed value and the transmittance, whereby appropriate shading correction can be performed.

In the second embodiment, in a case where the value of the exit pupil distance Z is not included in the information obtained by communication with the lens barrel 2 mounted on the mount portion 80, the camera control unit 30 selects the first processing (see steps S112 and S114 in FIG. 16 and step S210 in FIG. 17).

Even if the mounted lens barrel 2 is a communicable interchangeable lens, some models do not transmit the value of the exit pupil distance Z. Even in such a case, the correction coefficient is set according to the exit pupil distance Zf that is a fixed value and the transmittance, whereby appropriate shading correction can be performed.

In the third embodiment, in a case where the adapter 70 for mounting the interchangeable lens is mounted to the mount portion 80, the camera control unit 30 selects the first processing (see steps S120 and S121 in FIG. 18 and step S210 in FIG. 17).

The adapter 70 is mounted on the mount portion 80 in a case where the lens barrel 2 not corresponding to the mount portion 80 is mounted. In this case, it is determined that the value of the exit pupil distance cannot be acquired by communication, and the correction coefficient is set according to the exit pupil distance Zf that is a fixed value and the transmittance (see FIG. 18). Determination of mounting of the adapter 70 enables easy selection of processing.

In the first, second, and third embodiments, when the liquid crystal dimming element 11 is in the retracted state, the camera control unit 30 controls the shading correction processing by the camera signal processing unit 13 to OFF (see steps S103 and S105 in FIG. 14 and steps S102 and S105 in FIG. 16).

That is, the shading correction processing is performed only in a state in which shading caused by the liquid crystal dimming element 11 occurs.

Note that the effects described in the present specification are merely examples and are not limited, and other effects may be provided.

Note that the present technology can also adopt the following configurations.

(1)

An imaging device including:
a mount portion on which an interchangeable lens is mounted;
a liquid crystal dimming element that performs dimming of incident light incident through a lens system in an interchangeable lens when the interchangeable lens is mounted on the mount portion;
an imaging element that photoelectrically converts the incident light through the liquid crystal dimming element to generate a captured image signal;
a signal processing unit that performs signal processing on the captured image signal output from the imaging element; and
a control unit that causes the signal processing unit to execute shading correction processing of correcting shading caused by the liquid crystal dimming element with a correction coefficient set on the basis of a characteristic of an inclination of a liquid crystal of the liquid crystal dimming element.
   (2)

The imaging device according to (1), in which the control unit uses a value corresponding to a transmittance of the liquid crystal dimming element and a value of an exit pupil distance as a fixed value determined in advance, for determination of a correction coefficient to be indicated for the signal processing unit.

(3)

The imaging device according to (1) or (2), further including
a memory unit that stores a correction coefficient table that stores a correction coefficient for each of pixel values of a captured image signal for each of a plurality of transmittances of the liquid crystal dimming element with respect to a value of an exit pupil distance as a fixed value determined in advance, in which
the control unit refers to a correction coefficient table corresponding to a current transmittance and sets a correction coefficient for the shading correction processing.
   (4)

The imaging device according to (1) or (2), in which
for determination of a correction coefficient to be indicated for the signal processing unit, the control unit
selectively performs first processing of determining the correction coefficient by using an exit pupil distance as a fixed value determined in advance and a value corresponding to a transmittance of the liquid crystal dimming element, and second processing of determining the correction coefficient by using an exit pupil distance received from an interchangeable lens mounted on the mount portion and the value corresponding to the transmittance of the liquid crystal dimming element.
   (5)

The imaging device according to (4), further including
a memory unit that stores a correction coefficient table that stores a correction coefficient for each of pixel values of a captured image signal for each of a plurality of transmittances of the liquid crystal dimming element with respect to a plurality of values of exit pupil distances including the fixed value, in which
the control unit
in the first processing, refers to a correction coefficient table corresponding to a value of the exit pupil distance set as the fixed value and a current transmittance and sets a correction coefficient for the shading correction processing, and
in the second processing, refers to a correction coefficient table corresponding to a value of the exit pupil distance received from the interchangeable lens and the current transmittance and sets a correction coefficient for the shading correction processing.
   (6)

The imaging device according to (4) or (5), in which
the control unit
selects the first processing in a case where communication with the interchangeable lens mounted on the mount portion is not executable.
   (7)

The imaging device according to any of (4) to (6), in which
the control unit
selects the first processing in a case where a value of the exit pupil distance is not included in information obtained by communication with the interchangeable lens mounted on the mount portion.
   (8)

The imaging device according to any of (4) to (7), in which
the control unit
selects the first processing in a case where an adapter for mounting the interchangeable lens is mounted to the mount portion.
   (9)

The imaging device according to any of (1) to (8), in which
the liquid crystal dimming element is made retractable from an incident light path, and
the control unit controls the shading correction processing by the signal processing unit to OFF when the liquid crystal dimming element is in a retracted state.
   (10)

A shading correction method for an imaging device including: a mount portion on which an interchangeable lens is mounted; a liquid crystal dimming element that performs dimming of incident light incident through a lens system in an interchangeable lens when the interchangeable lens is mounted on the mount portion; an imaging element that photoelectrically converts the incident light through the liquid crystal dimming element. to generate a captured image signal; and a signal processing unit that performs signal processing on the captured image signal output from the imaging element,
the shading correction method including executing, by the signal processing unit, shading correction processing of correcting shading caused by the liquid crystal dimming element with a correction coefficient set on the basis of a characteristic of an inclination of a liquid crystal of the liquid crystal dimming element.

### REFERENCE SIGNS LIST

1 Imaging device
2 Lens barrel
11 Liquid crystal dimming element
12 Imaging element
13 Camera signal processing unit
30 Camera control unit
31 Memory unit
32 Dimming drive circuit
34 Communication unit
40 Liquid crystal molecule
61, 64 Correction value output unit
62, 65 Correction value setting unit
63, 66 Information acquisition unit
67 Dimming control unit
68 Communication processing unit
69 Correction ON/OFF setting unit
70 Adapter
71, 72 Coefficient multiplier
80 Mount portion

1. An imaging device comprising:
a mount portion on which an interchangeable lens is mounted;
a liquid crystal dimming element that performs dimming of incident light incident through a lens system in an interchangeable lens when the interchangeable lens is mounted on the mount portion;
an imaging element that photoelectrically converts the incident light through the liquid crystal dimming element to generate a captured image signal;
a signal processing unit that performs signal processing on the captured image signal output from the imaging element; and
a control unit that causes the signal processing unit to execute shading correction processing of correcting shading caused by the liquid crystal dimming element with a correction coefficient set on a basis of a characteristic of an inclination of a liquid crystal of the liquid crystal dimming element.

2. The imaging device according to claim 1, wherein
the control unit uses a value corresponding to a transmittance of the liquid crystal dimming element and a value of an exit pupil distance as a fixed value determined in advance, for determination of a correction coefficient to be indicated for the signal processing unit.

3. The imaging device according to claim 1, further comprising
a memory unit that stores a correction coefficient table that stores a correction coefficient for each of pixel values of a captured image signal for each of a plurality of transmittances of the liquid crystal dimming element with respect to a value of an exit pupil distance as a fixed value determined in advance, wherein
the control unit refers to a correction coefficient table corresponding to a current transmittance and sets a correction coefficient for the shading correction processing.

4. The imaging device according to claim 1, wherein,
for determination of a correction coefficient to be indicated for the signal processing unit, the control unit
selectively performs first processing of determining the correction coefficient by using an exit pupil distance as a fixed value determined in advance and a value corresponding to a transmittance of the liquid crystal dimming element, and second processing of determining the correction coefficient by using an exit pupil distance received from an interchangeable lens mounted on the mount portion and the value corresponding to the transmittance of the liquid crystal dimming element.

5. The imaging device according to claim 4, further comprising
a memory unit that stores a correction coefficient table that stores a correction coefficient for each of pixel values of a captured image signal for each of a plurality of transmittances of the liquid crystal dimming element with respect to a plurality of values of exit pupil distances including the fixed value, wherein
the control unit
in the first processing, refers to a correction coefficient table corresponding to a value of the exit pupil distance set as the fixed value and a current transmittance and sets a correction coefficient for the shading correction processing, and
in the second processing, refers to a correction coefficient table corresponding to a value of the exit pupil distance received from the interchangeable lens and the current transmittance and sets a correction coefficient for the shading correction processing.

6. The imaging device according to claim 4, wherein
the control unit
selects the first processing in a case where communication with the interchangeable lens mounted on the mount portion is not executable.

7. The imaging device according to claim 4, wherein
the control unit
selects the first processing in a case where a value of the exit pupil distance is not included in information obtained by communication with the interchangeable lens mounted on the mount portion.

8. The imaging device according to claim 4, wherein
the control unit
selects the first processing in a case where an adapter for mounting the interchangeable lens is mounted to the mount portion.

9. The imaging device according to claim 1, wherein
the liquid crystal dimming element is made retractable from an incident light path, and
the control unit controls the shading correction processing by the signal processing unit to OFF when the liquid crystal dimming element is in a retracted state.

10. A shading correction method for an imaging device including: a mount portion on which an interchangeable lens is mounted; a liquid crystal dimming element that performs dimming of incident light incident through a lens system in an interchangeable lens when the interchangeable lens is mounted on the mount portion; an imaging element that photoelectrically converts the incident light through the liquid crystal dimming element to generate a captured image signal, and a signal processing unit that performs signal processing on the captured image signal output from the imaging element,
the shading correction method comprising executing, by the signal processing unit, shading correction processing of correcting shading caused by the liquid crystal dimming element with a correction coefficient set on a basis of a characteristic of an inclination of a liquid crystal of the liquid crystal dimming element.
